(19) United States
(12) Patent Application Publication
(10) Pub. No.: US 2024/0154478 A1
(43) Pub. Date: May 9, 2024

(54) LAMINATED IRON CORE MANUFACTURING METHOD AND LAMINATED IRON CORE

(71) Applicant: NHK SPRING CO., LTD., Yokohama-shi, Kanagawa (JP)

(72) Inventors: Michinobu HIRAMA, Yokohama-shi, Kanagawa (JP); Takeshi HAGIWARA, Yokohama-shi, Kanagawa (JP)

(21) Appl. No.: 18/548,768

(22) PCT Filed: Mar. 2, 2022
(86) PCT No.: PCT/JP2022/008852

§ 371 Date: Sep. 1, 2023

(30) Foreign Application Priority Data
Mar. 15, 2021 (JP) 2021-041801

(51) Int. Cl. H02K 1/276; H02K 15/03

(52) U.S. Cl. CPC H02K 1/276; H02K 15/03; H02K 2201/09

(57) ABSTRACT

Forming a caulking portion involves forming: a planar portion that is connected to a main body of an iron core piece, that is formed into a concave shape with respect to a face of the iron core piece which is on one side in the thickness direction, that formed into a convex shape with respect to a face of the iron core piece which is on another side in the thickness direction, and that is parallel to the faces; and a pair of extended portions that include a pair of sloped portions which extend out obliquely from both ends, along the lengthwise direction of the caulking portion, of the planar portion, toward mutually opposite sides in the lengthwise direction and toward another side in the thickness direction. Forming the pair of sloped portions involves extending the pair of sloped portions in the oblique directions.

### TECHNICAL FIELD

The present disclosure relates to a laminated iron core and a method of manufacturing the same.

### BACKGROUND ART

In a caulking structure of a laminated and bonded article described in Japanese Utility Model No. 3046084, thin plates are connected to each other by vertically engaging caulking portions formed in the thin plates according to a press working, and a laminated and bonded article is assembled. The caulking portion mentioned above is constructed by a pair of right and left elastic pieces which are formed by punching the thin plate into an approximately inverted v shape in the side view, and a pair of right and left openings which are formed in the thin plates by the punching work of the elastic piece. The caulking portion is formed into an elongated shape in which an arranging direction of a pair of elastic pieces is a lengthwise direction, and a pair of elastic pieces are formed into such a shape that leading ends thereof are curved downward. In this caulking structure, when the thin plates are laminated, a pair of elastic pieces formed in one thin plate are respectively fitted into a pair of openings formed in the other thin plate, and the thin plates are caulked at two positions and are connected.

### SUMMARY OF INVENTION

### Technical Problem

In the prior art mentioned above, a pair of elastic pieces are formed into a curved shape which tends to be elastically deformed in a lengthwise direction of a caulking portion. Therefore, there is room for improvement in the light of enhancing a caulking rigidness of the caulking portion in the lengthwise direction. Further, a position between a pair of elastic portions in the caulking portion is not utilized for caulking. Therefore, there is room for improvement in the light of enhancing a caulking force of the thin plate in a thickness direction. Further, a pair of elastic pieces interfere with each other in the thickness direction of the thin plate, and a gap between plates may be generated between the thin plates. Therefore, there is room for improvement in the light of reducing the gap between plates.

An object of the present disclosure is to obtain a laminated iron core manufacturing method and a laminated iron core which can enhance a caulking rigidness of a caulking portion in a lengthwise direction and a caulking force of an iron core piece in a thickness direction.

### Solution to Problem

A method of manufacturing a laminated iron core according to a first aspect is a method of manufacturing a laminated iron core by fitting elongate caulking portions, formed in each of iron core pieces via press working, to each other and laminating and fixing the iron core pieces to each other, the method including the steps of forming a planar portion, which is connected to a main body of the iron core piece when forming the caulking portion, which is formed into a concave shape with respect to a face of one side of the iron core piece in a thickness direction, which is formed into a convex shape with respect to a face of another side of the iron core piece in the thickness direction, and which is parallel to each of the faces, and forming a pair of extended portions having a pair of sloped portions which extend obliquely toward an opposite side in the lengthwise direction and another side in the thickness direction from both ends of the planar portion in the lengthwise direction of the caulking portion, and extending the pair of sloped portions in an oblique direction when forming the pair of sloped portions.

The term “parallel” in the first aspect is not required to be accurately parallel, but may be approximately parallel. Same applies to the term “parallel” in a second aspect and a third aspect.

In the method of manufacturing the laminated iron core according to the first aspect, the laminated iron core is manufactured by fitting the elongate caulking portions formed in each of the iron core pieces via press working to each other and laminating and fixing the iron core pieces to each other. When forming the caulking portion, the planar portion and a pair of extended portions are formed. The planar portion is connected to the main body of the iron core piece, is formed into the concave shape with respect to the face of the one side of the iron core piece in the thickness direction, is formed into the convex shape with respect to the face of another side of the iron core piece in the thickness direction, and is parallel to each of the faces. A pair of extended portions have a pair of sloped portions which extend obliquely toward the opposite side in the lengthwise direction and another side in the thickness direction each other from both ends of the planar portion in the lengthwise direction of the caulking portion.

The pair of sloped section can be formed into such a shape that is hard to be elastically deformed in the lengthwise direction of the caulking portion, for example, by setting an inclination angle with respect to the main body of the iron core piece small. Thus, it is possible to enhance a caulking rigidness of the caulking portion in the lengthwise direction. Further, in the caulking portion mentioned above, the planar portion between a pair of sloped portions is utilized for caulking fitting. Therefore, it is possible to enhance a caulking force of the iron core piece in the thickness direction. Further, when forming a pair of sloped portions, a pair of sloped portions extend in the oblique direction. Thus, a thickness of a pair of sloped section is thinner at least partly than the main body of the iron core piece. Therefore, the sloped portions of each of the iron core pieces are hard to be interfered with each other in the thickness direction of the iron core piece. As a result, the gap between plates is reduced, and it is possible to further enhance the caulking rigidness and the caulking force.

A laminated iron core according to a second aspect is a laminated iron core in which elongate caulking portions formed in each of iron core pieces according to press working are fitted to each other and each of the iron core pieces is laminated and fixed to each other, wherein the caulking portion is provided with a planar portion which is connected to a main body of the iron core piece, which is formed into a concave shape with respect to a face of one side of the iron core piece in a thickness direction, which is formed into a convex shape with respect to a face of another side of the iron core piece in the thickness direction, and which is parallel to each of the faces, and a pair of extended portions having a pair of sloped portions which extend obliquely toward an opposite side in the lengthwise direction and another side in the thickness direction from both ends of the planar portion in the lengthwise direction of the caulking portion, and are thinner at least partly than the main body of the iron core piece.

In the laminated iron core according to the second aspect, the elongate caulking portions formed in each of the iron core pieces via press working is fitted to each other and each of the iron core pieces is laminated and fixed to each other. The caulking portion is provided with the planar portion and a pair of extended portions. The planar portion is connected to the main body of the iron core piece, is formed into the concave shape with respect to the face of the one side of the iron core piece in the thickness direction, is formed into the convex shape with respect to the face of another side of the iron core piece in the thickness direction, and is parallel to each of the faces. A pair of extended portions have a pair of sloped portions which extend obliquely toward the opposite side in the lengthwise direction and another side in the thickness direction each other from both ends of the planar portion in the lengthwise direction of the caulking portion.

The pair of sloped section can be formed into such a shape that is hard to be elastically deformed in the lengthwise direction of the caulking portion, for example, by setting an inclination angle with respect to the main body of the iron core piece small. Thus, it is possible to enhance a caulking rigidness of the caulking portion in the lengthwise direction. Further, in the caulking portion mentioned above, the planar portion between a pair of sloped portions is utilized for caulking fitting. Therefore, it is possible to enhance a caulking force of the iron core piece in the thickness direction. Further, a pair of sloped portions are thinner at least partly than the main body of the iron core piece. Therefore, the sloped portions of each of the iron core pieces are hard to be interfered with each other in the thickness direction of the iron core piece. As a result, the gap between plates is reduced, and it is possible to further enhance the caulking rigidness and the caulking force.

A laminated iron core according to a third aspect is the laminated iron core according to the second aspect, wherein the pair of extended portions have a pair of outer-side planar portions which extend toward an opposite side in the lengthwise direction from an end portion of an opposite side to the planar portion in the pair of sloped section, and which are parallel to each of the faces.

In the laminated iron core according to the third aspect, the pair of outer-side planar portions included in the pair of extended portions of the caulking portion extend toward the opposite side in the lengthwise direction each other from the end portion in the opposite side to the planar portion in the pair of sloped section. A contact area between the caulking portion in each of the iron core pieces can be increased by these outer-side planar portions, and it is accordingly possible to further enhance the caulking force.

A laminated iron core according to a fourth aspect is the laminated iron core according to the second aspect or the third aspect, wherein, in a case in which the thickness of the iron core piece is 1, a depth that the planar portion is recessed from the face of the one side in the thickness direction is set to a range from 0.15 to 0.85.

In the laminated iron core according to the fourth aspect, the depth that the planar portion of the caulking portion is recessed from the face of the one side of the iron core piece in the thickness direction is set to the above-described range. Thus, it is possible to secure the caulking force between the caulking portions in the planar portion while securing the connection strength between the planar portion and the main body of the iron core piece.

A laminated iron core according to a fifth aspect is the laminated iron core according to any one of the second to fourth aspects, wherein the pair of extended portions are directly connected to the main body at an end portion at an opposite side to the planar portion.

In the laminated iron core according to the fifth aspect, the end portion in the opposite side to the planar portion in the pair of extended portions is directly supported to the main body of the iron core piece on the basis of the structure as mentioned above. Thus, a pair of extended portions are hard to be accidentally deformed, and it is possible to enhance the caulking force of the iron core piece in the thickness direction.

A laminated iron core according to a sixth aspect is the laminated iron core according to any one of the second to fourth aspects, wherein the pair of extended portions are not directly connected to the main body at the end portion at an opposite side to the planar portion.

In the laminated iron core according to the sixth aspect, the pair of extended portions can be arranged so as to protrude more from the face of another side of the iron core piece in the thickness direction on the basis of the structure as mentioned above. Thus, it is possible to increase the contact area between the caulking portions in the pair of extended portions and it is possible to enhance the caulking force of the iron core piece in the thickness direction.

A laminated iron core according to a seventh aspect is the laminated iron core according to the first aspect or the second aspect, wherein a plurality of the caulking portions are formed in each of the iron core pieces so as to be connected to each other in the lengthwise direction.

In the laminated iron core according to the seventh aspect, it is possible to increase the contact area, for example, between the caulking portions, and it is possible to enhance the caulking force of the iron core piece in the thickness direction on the basis of the structure as mentioned above.

A laminated iron core according to an eighth aspect is the laminated iron core according to the third aspect or any one of the fourth to seventh aspects reciting the third aspect, wherein the pair of extended portions have a pair of outer-side sloped portions which extend obliquely toward the opposite side in the lengthwise direction and the one side in the thickness direction each other from the end portion in the opposite side to the pair of sloped portions in the pair of outer-side planar portions, and are thinner at least partly than the main body.

In the laminated iron core according to the eighth aspect, the pair of outer-side sloped portions included in the pair of extended portions of the caulking portion extend obliquely toward the opposite side of the caulking portion in the lengthwise direction and the one side of the iron core piece in the thickness direction from the end portion in the opposite side to the pair of sloped portions in the pair of outer-side planar portions. Owing to the outer-side sloped portions, it is possible to guide the caulking fitting between the caulking portions of each of the iron core pieces. Further, the pair of outer-side sloped portions are thinner at least partly than the main body of the iron core piece, and the pair of outer-side sloped portions are accordingly hard to be interfered with each other in the thickness direction of the iron core piece. As a result, the gap between plates is hard to be generated, and it is possible to secure the effect of enhancing the caulking rigidness and the caulking force mentioned above.

A laminated iron core according to a ninth aspect is the laminated iron core according to the third aspect or any one of the fourth to seventh aspects reciting the third aspect, wherein each of the outer-side planar portions includes structures which are arranged at different positions from each other in the thickness direction.

In the laminated iron core according to the ninth aspect, each of the outer-side planar portions of the caulking portion includes the structures which are arranged at different positions from each other in the thickness direction of the iron core pieces. Therefore, it is possible to differentiate the caulking force between the caulking portions in each of the outer-side planar portions. Thus, a degree of freedom for setting the caulking force is improved.

### Advantageous Effects of Invention

As described above, in the laminated iron core manufacturing method and the laminated iron core according to the present disclosure, it is possible to enhance the caulking rigidness of the caulking portion in the lengthwise direction and the caulking force of the iron core piece in the thickness direction.

### BRIEF DESCRIPTION OF DRAWINGS

FIG. 1 is a plan view showing a structure of a laminated iron core according to a first embodiment.

FIG. 2 is a perspective view showing a periphery of a caulking portion in an iron core piece of the laminated iron core according to the first embodiment in a state in which the periphery is viewed from one side of the iron core piece in a thickness direction.

FIG. 3 is a perspective view showing the periphery of the caulking portion in the iron core piece of the laminated iron core according to the first embodiment in a state in which the periphery is viewed from another side of the iron core piece in the thickness direction.

FIG. 4 is a perspective view showing a part of FIG. 2 in a state in which the part is viewed from a different direction from FIG. 2.

FIG. 5 is a perspective view showing a part of FIG. 3 in a state in which the part is viewed from a different direction from FIG. 3.

FIG. 6 is a cross sectional view showing a cut plane along a line F6-F6 in FIG. 2.

FIG. 7 is a cross sectional view showing a condition when the iron core piece is laminated and corresponding to FIG. 6.

FIG. 8A is a first cross sectional view showing a method of forming a caulking portion having a V-shaped cross section.

FIG. 8B is a second cross sectional view showing the method of forming the caulking portion having the V-shaped cross section.

FIG. 9A is a first cross sectional view showing a method of forming a caulking portion having a stepped cross sectional shape.

FIG. 9B is a second cross sectional view showing the method of forming the caulking portion having the stepped cross sectional shape.

FIG. 10A is a first cross sectional view showing the other method of forming a caulking portion having a V-shaped cross section.

FIG. 10B is a second cross sectional view showing the other method of forming the caulking portion having the V-shaped cross section.

FIG. 11A is a first cross sectional view showing a method of forming a caulking portion in the first embodiment.

FIG. 11B is a second cross sectional view showing the method of forming the caulking portion in the first embodiment.

FIG. 12 is a cross sectional view showing a structure of a periphery of a caulking portion in an iron core piece of a laminated iron core according to a second embodiment and corresponding to FIG. 6.

FIG. 13 is a cross sectional view showing a structure of a periphery of a caulking portion in an iron core piece of a laminated iron core according to a third embodiment and corresponding to FIG. 6.

FIG. 14 is a cross sectional view showing a structure of a periphery of a caulking portion in an iron core piece of a laminated iron core according to a fourth embodiment and corresponding to FIG. 6.

FIG. 15 is a cross sectional view showing a structure of a periphery of a caulking portion in an iron core piece of a laminated iron core according to a fifth embodiment and corresponding to FIG. 6.

FIG. 16 is a cross sectional view showing a structure of a periphery of a caulking portion in an iron core piece of a laminated iron core according to a sixth embodiment and corresponding to FIG. 6.

### DESCRIPTION OF EMBODIMENTS

### First Embodiment

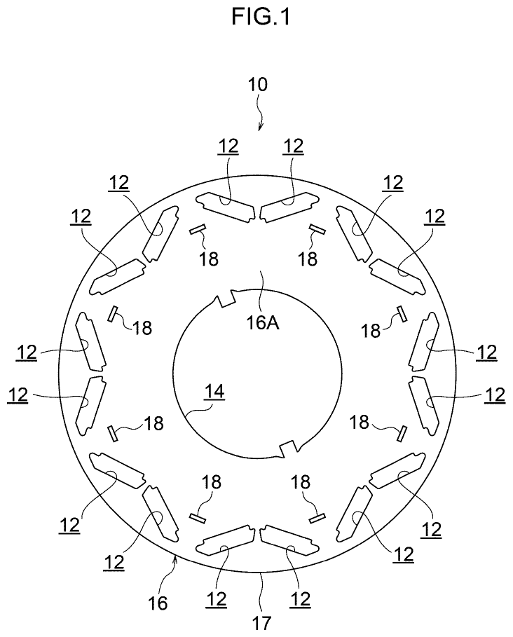

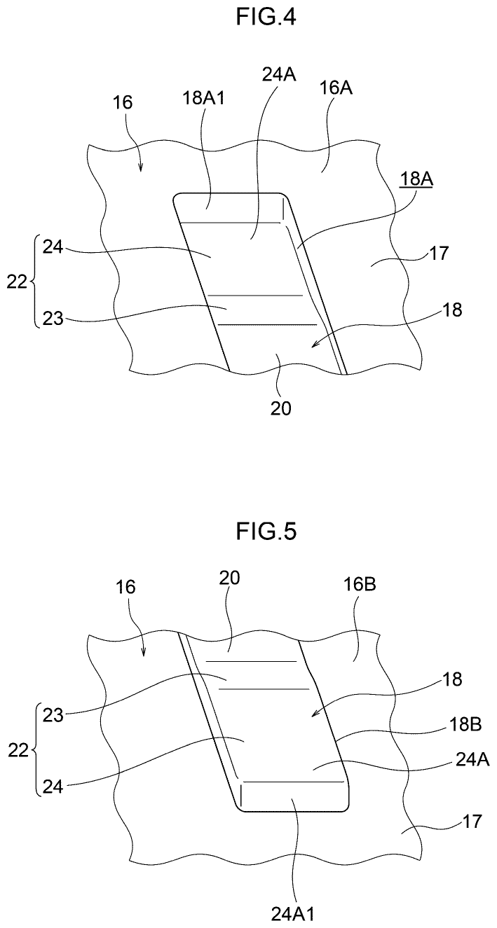

A description will be given below of a laminated iron core 10 according to a first embodiment of the present disclosure and a method of manufacturing the same with reference to FIGS. 1 to 11B. In each of the drawings, partial reference signs may be omitted for the sake of easy viewing.

(Structure)

The laminated iron core 10 according to the first embodiment is manufactured by a laminated iron core manufacturing method according to the first embodiment. The laminated iron core 10 constructs a major part of a rotor disposed in an inner rotor type motor, for example, and is formed into a cylindrical shape. The rotor mentioned above is a magnet embedded type, and a plurality of magnet insertion holes 12 are formed in an outer peripheral portion of the laminated iron core 10. Permanent magnets (not shown) are respectively inserted into the magnet insertion holes 12. A fitting hole 14 passing through the laminated iron core 10 in an axial direction is formed in a center portion of the laminated iron core 10. A rotary shaft (not shown) is inserted into the fitting hole 14.

The laminated iron core 10 is structured such that a lot of iron core pieces 16 are laminated. Each of the iron core pieces 16 is formed into a ring-like disc shape by an electromagnetic steel sheet. A plurality of (eight here) caulking portions 18 are formed in an outer peripheral portion of each of the iron core pieces 16. Each of the caulking portions 18 is a dowel formed by press working of the electromagnetic steel sheet constructing the iron core piece 16, and is formed into such an elongated rectangular shape that a peripheral direction of the iron core piece 16 is a lengthwise direction as viewed from a thickness direction of the iron core piece 16 (direction perpendicular to a plane of paper in FIG. 1).

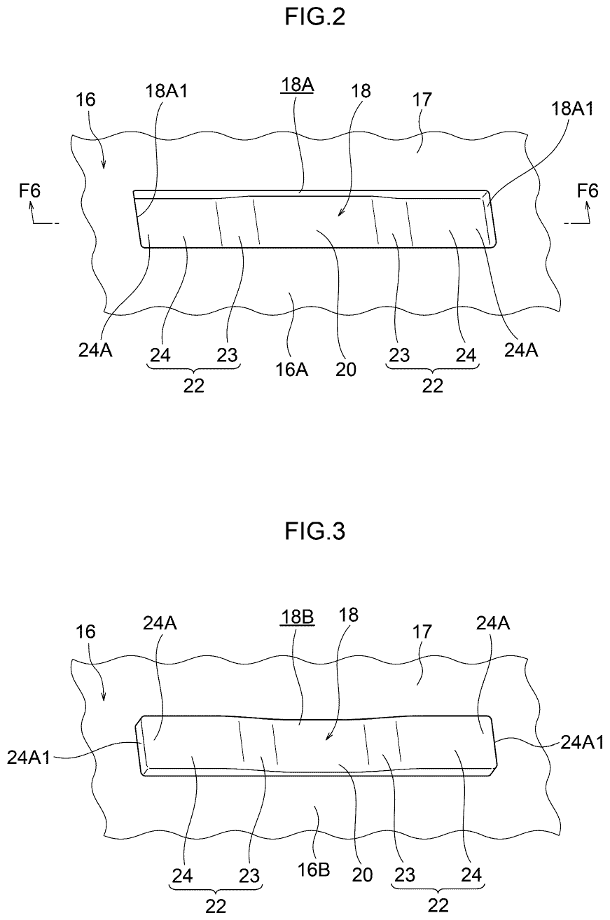

As shown in FIGS. 2 to 6, the caulking portion 18 mentioned above is formed into the concave shape with respect to a face 16A in one side (hereinafter, refer to “one side face 16A”) in a thickness direction of the iron core piece 16, and is formed into the convex shape with respect to a face 16B of another side (hereinafter, refer to “other side face 16B”) in the thickness direction of the iron core piece 16. A caulking concave portion 18A recessed with respect to the one side face 16A is formed at a position where the caulking portion 18 is formed in the one side face 16A of the iron core piece 16. A caulking convex portion 18B protruding out of another side face 16B is formed at a position where the caulking portion 18 is formed in the iron core piece 16.

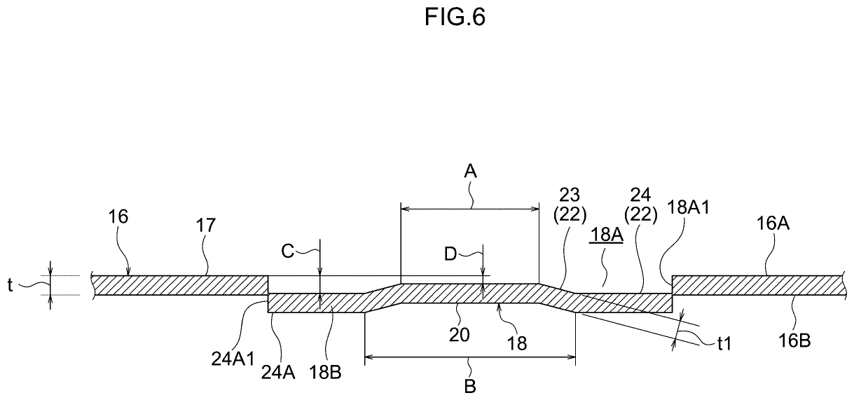

The caulking portion 18 is provided with a planar portion 20 and a pair of extended portions 22, and a pair of extended portions 22 have a pair of sloped portions 23 and a pair of outer-side planar portions 24. The planar portion 20 and a pair of extended portions 22 are connected to a main body 17 of the iron core piece 16. The planar portion 20 is formed into the concave shape with respect to the one side face 16A of the iron core piece 16, and is formed into the convex shape with respect to another side face of the iron core piece 16. The planar portion 20 is formed into a rectangular plate shape, and is arranged in parallel to the one side face 16A and another side face 16B. As shown in FIG. 6, a depth D that the planar portion 20 is recessed from the one side face 16A is set to a range from 0.15 to 0.85 when a thickness t of the iron core piece 16 is 1 (0.15t≤D≤0.85t).

A pair of sloped portions 23 extend obliquely toward an opposite side to a lengthwise direction of the caulking portion 18 and another side of a thickness direction of the iron core piece 16 each other from both ends of the planar portion 20 in the lengthwise direction of the caulking portion 18. Each of the sloped portions 23 is formed into a rectangular plate shape, and is set to be thinner at least partly (approximately all in this case) than the main body 17 (t1<t in FIG. 6). A dimension B of the planar portion 20 and a pair of sloped portions 23 in the lengthwise direction of the caulking portion 18 is set to be greater than a dimension A of the planar portion 20 in the lengthwise direction of the caulking portion 18 (A<B).

A pair of outer-side planar portions 24 extend toward an opposite side to the lengthwise direction of the caulking portion 18 each other from an end portion of an opposite side to the planar portion 20 in a pair of sloped portions 23. Each of the outer-side planar portions 24 is formed into a rectangular plate shape, and is arranged in parallel to the one side face 16A and another side face 16B. The term “parallel” described with regard to the planar portion 20 and the outer-side planar portion 24 is not required to be accurately parallel, but may be approximately parallel.

As shown in FIG. 6, a depth C that each of the outer-side planar portions 24 is recessed from the one side face 16A is set to be greater than a depth D that the planar portion 20 is recessed from the one side face 16A (D<C). In other words, each of the outer-side planar portions 24 is arranged of another side of the iron core piece 16 in the thickness direction rather than the planar portion 20. In the present embodiment, the depth C that each of the outer-side planar portions 24 is recessed from the one side face 16A is set to be smaller than the thickness t of the iron core piece 16.

End portions 24A of an opposite side to a pair of sloped portions 23 in a pair of outer-side planar portions 24 are end portions of an opposite side to the planar portion 20 in a pair of extended portions 22, and are end portions of the caulking portion 18 in the lengthwise direction. These end portions 24A are directly connected to the main body 17 of the iron core piece 16. End surfaces 24A1 heading for an outer side of the caulking portion 18 in the lengthwise direction are formed at the end portions 24A. These end surfaces 24A1 are arranged vertically or approximately vertically with respect to the lengthwise direction of the caulking portion 18.

In the iron core piece 16 having the structure mentioned above, the caulking portion 18 is formed according to press working using a punch and a die. When a pair of sloped portions 23 are formed by the press working, a pair of sloped portions 23 extend (drawn out) in an oblique direction that a pair of sloped portions 23 extend out of the planar portion 20. On the basis of the extension, a thickness of at least a part (approximately all in this case) of each of the sloped section 23 is adapted to be thinner than the thickness of the planar portion 20.

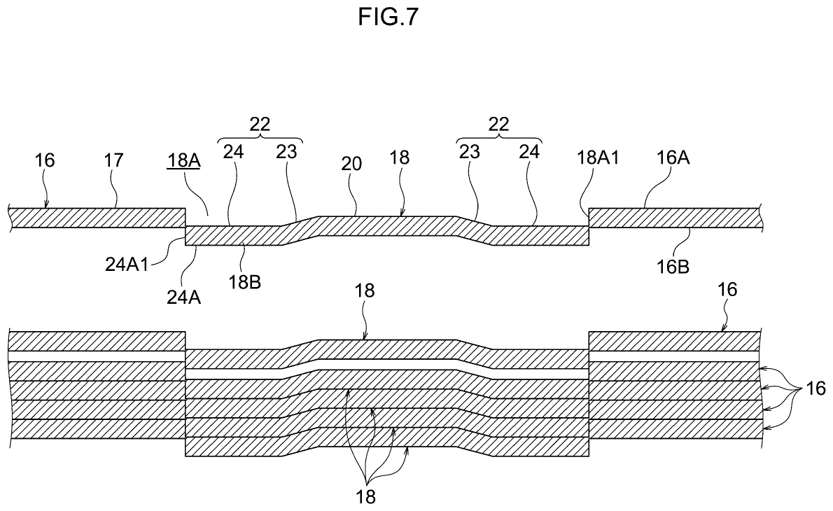

As shown in FIG. 7, when a lot of iron core pieces 16 are laminated, the caulking portions 18 of each of the iron core piece 16 are fitted to each other and each of the iron core pieces 16 is laminated and fixed to each other. At this time, the caulking convex portion 18B is fitted into the caulking concave portion 18A, and each of the iron core pieces 16 is accordingly fixed. In a state in which the caulking convex portion 18B is fitted to the caulking concave portion 18A, an end surface 18A1 of the caulking concave portion 18A of the caulking portion 18 in the lengthwise direction and the end surfaces 24A1 of a pair of outer-side extended portions 24 are adapted to face each other in the lengthwise direction of the caulking portion 18 (that is, a peripheral direction of the iron core piece 16) and come into contact with each other.

(Operation and Effect)

Next, a description will be given of an operation and an effect of the present embodiment.

In the laminated iron core 10 having the structure mentioned above, the elongate caulking portions 18 formed in the iron core pieces 16 via press working are fitted to each other and the iron core pieces 16 are laminated and fixed to each other. The caulking portion 18 is provided with the planar portion 20 and a pair of extended portions 22. The planar portion 20 is connected to the main body 17 of the iron core piece 16, is formed into the concave shape with respect to the one side face 16A of the iron core piece 16, is formed into the convex shape with respect to another side face 16B of the iron core piece 16, and is in parallel to the one side face 16A and another side face 16B. A pair of extended portions 22 have a pair of sloped portions 23 which extend obliquely toward the opposite side to the lengthwise direction of the caulking portion 18 and another side of the thickness direction of the iron core piece 16 each other from both ends of the planar portion 20 in the lengthwise direction of the caulking portion 18.

A pair of sloped portions 23 can be formed into such a shape as to be hard to be elastically deformed in the lengthwise direction of the caulking portion 18, for example, by setting an inclination angle for the main body 17 of the iron core piece 16 small. Thus, it is possible to enhance the caulking rigidness of the caulking portion 18 in the lengthwise direction. As a result, for example, in a case where each of the iron core pieces 16 is laminated according to an internal die rotary lamination with a high speed press, torsion around an axis is hard to be generated between the iron core pieces 16. Thus, it is easy to inhibit each of the iron core pieces 16 from being separated due to the torsion, and it is easy to manufacture the laminated iron core 10.

Further, in the caulking portion 18 mentioned above, the planar portion 20 between a pair of sloped portions 23 is utilized for caulking fitting. Therefore, it is possible to enhance the caulking force of the iron core piece 16 in the thickness direction. Further, a pair of sloped portions 23 are set to be thinner at least partly than the main body 17. Therefore, the sloped portions 23 of the iron core pieces 16 are hard to be interfered with each other in the thickness direction of the iron core pieces 16. As a result, the gap between plates is reduced, and it is possible to further enhance the caulking rigidness and the caulking force.

Further, in the laminated iron core 10, a pair of outer-side planar portions 24 included in a pair of extended portions 22 of the caulking portion 18 extend toward opposite sides to each other in the lengthwise direction from an end portion of an opposite side to the planar portion 20 in a pair of sloped portions 23. The contact area between the caulking portions 18 of the iron core pieces 16 can be increased by the outer-side planar portions 24, and it is possible to further enhance the caulking force. In particular, the effect mentioned above is increased in a case where the iron core piece 16 is constructed by the thin plate.

Further, in the laminated iron core 10, when the thickness of the iron core piece 16 is 1, the depth that the planar portion 20 is recessed from the one side face 16A of the iron core piece 16 is set to the range from 0.15 to 0.85. Thus, it is possible to secure the caulking force between the caulking portions 18 in the planar portion 20 while securing the connection strength between the planar portion 20 and the main body 17 of the iron core piece 16.

Further, in the laminated iron core 10, a pair of extended portions 22 are directly connected to the main body 17 of the iron core piece 16 at the end portion 24A in the opposite side to the planar portion 20. Therefore, the end portions 24A of a pair of extended portions 22 are directly supported to the main body 17 of the iron core piece 16. Thus, a pair of extended portions 22 are hard to be accidentally deformed, and it is possible to enhance the caulking force in the thickness direction of the iron core piece 16.

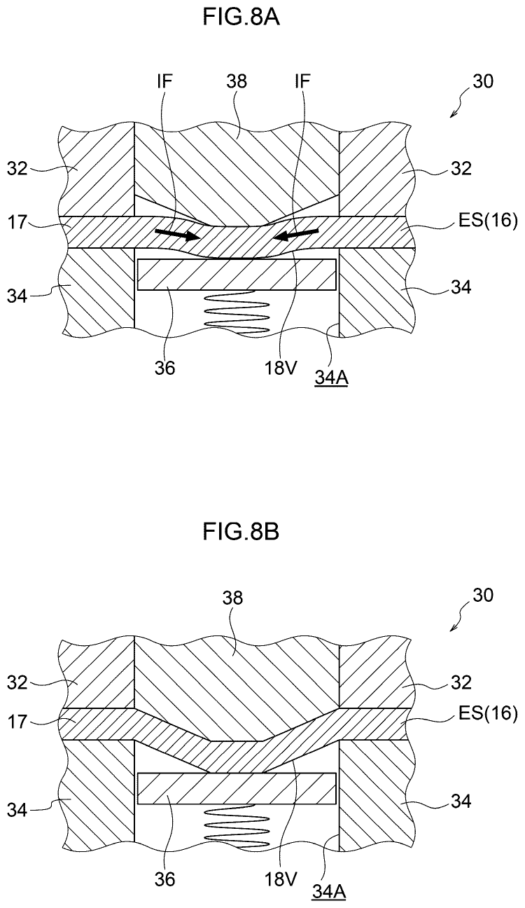

A description will be supplementarily given below of the effect of the present embodiment with reference to FIGS. 8A to 11B. In FIGS. 8A to 11B, reference numeral 30 denotes a metal mold, reference numeral 32 denotes a sheet holder, reference numeral 34 denotes a die, reference numeral 36 denotes a push-up mechanism, and reference numeral 38 denotes a caulking punch.

In a case where a caulking portion 18V having a V-shaped cross section is formed, such as a first comparative example shown in FIGS. 8A and 8B, an electromagnetic steel sheet ES pressed against the die 34 by the sheet holder 32 is pushed into a die hole 34A by a caulking punch 38, and a caulking portion 18V (dowel) having a convex shape is accordingly formed of an opposite side to the caulking punch 38 in the electromagnetic steel sheet ES. The push-up mechanism 36 applies pressure (back pressure) toward the caulking punch 38 side to the caulking portion 18V entering into the die hole 34A, thereby separating the caulked electromagnetic steel sheet ES from the die. In the first comparative example, the material more flows into the caulking portion 18V side from the main body 17 side (refer to an arrow IF in FIG. 8A), and it is therefore hard to make the thickness of the sloped section of the caulking portion 18V thin.

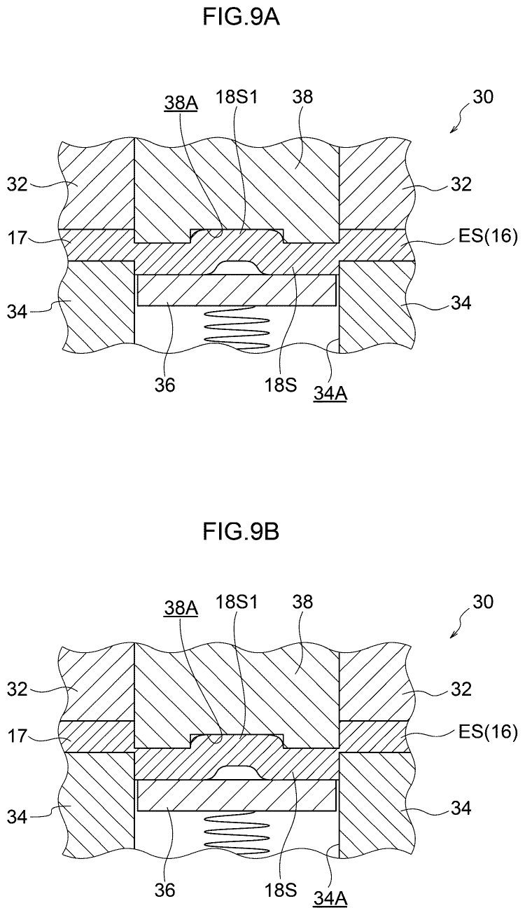

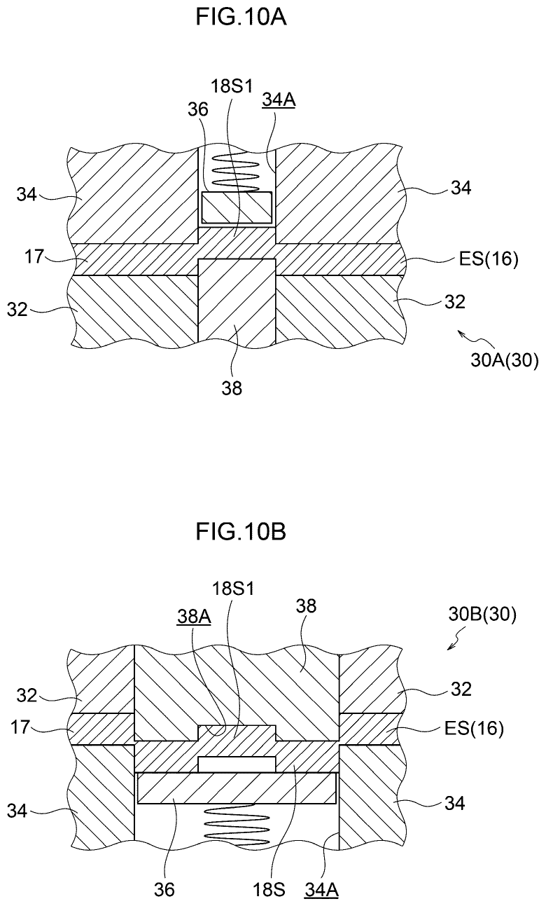

On the contrary, in a case where a step-shaped caulking portion 18S is formed by one step, such as a second comparative example shown in FIGS. 9A and 9B, it is necessary to allow a part 18S1 of the electromagnetic steel sheet ES to enter into a concave portion 38A formed in the caulking punch 38. However, a corner portion of the part 18S1 comes to a round shape. In order to dissolve this, in a case where the caulking portion 18S is formed by two steps, such as a third comparative example shown in FIGS. 10A and 10B, the number of steps is increased, and two kinds of metal molds 30A and 30B shown in FIGS. 10A and 10B are required. As a result, a manufacturing cost is increased.

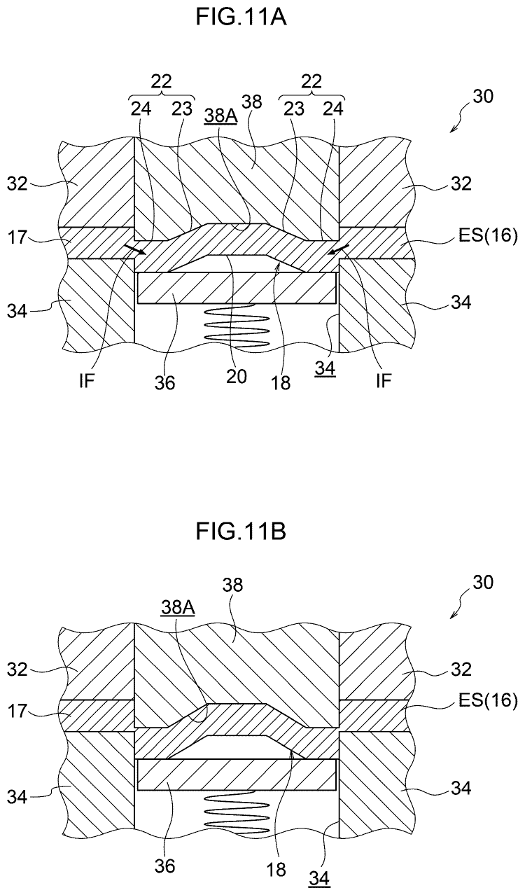

In contrast to these, in a case where the caulking portion 18 in which a pair of sloped portions 23 extend from the planar portion 20 such as the present embodiment shown in FIGS. 11A and 11B, the material less flows into a pair of extended portions 22 side from the main body 17 side (refer to an arrow IF in FIG. 11A), and it is therefore easy to make the thickness of the sloped section 23 thin. Further, the planar portion 20 and a pair of sloped portions 23 enter into the concave portion 38A formed in the caulking punch 38, and it is therefore easy to prevent the corner portion between the planar portion 20 and a pair of sloped portions 23 from coming to the round shape.

Next, a description will be given of the other embodiments according to the present disclosure. For basically the same structures and operations as the first embodiment, the same reference signs as the first embodiment are attached and a description thereof will be omitted.

### Second Embodiment

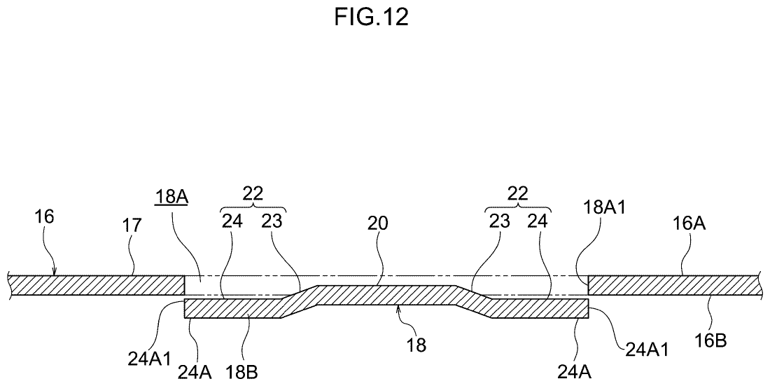

FIG. 12 is a cross sectional view showing a structure around a caulking portion 18 in an iron core piece 16 of a laminated iron core according to a second embodiment of the present disclosure. In the caulking portion 18, an end portion 24A of an opposite side to a planar portion 20 in a pair of extended portions 22 is not directly connected to a main body 17 of the iron core piece 16. Thus, it is possible to arrange a pair of extended portions 22 so as to protrude out of another side face 16B of the iron core piece 16. Thus, it is possible to increase a contact area between the caulking portions 18 in a pair of extended portions 22, and it is therefore possible to enhance a caulking force of the iron core piece 16 in a thickness direction. In this embodiment, the other structures than the above are the same as the first embodiment.

Therefore, the same effects as the first embodiment can be basically obtained except the above points.

### Third Embodiment

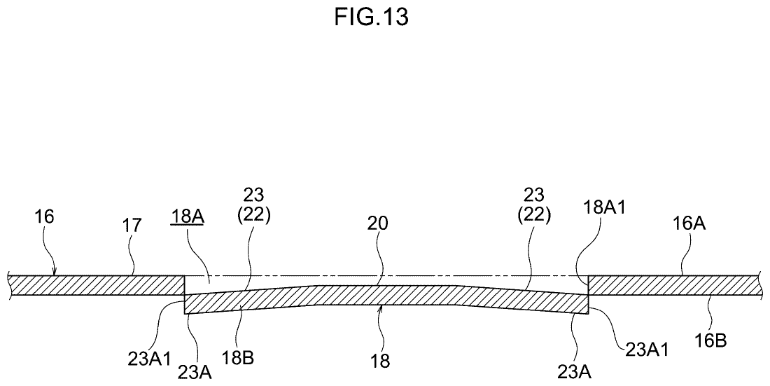

FIG. 13 is a cross sectional view showing a structure around a caulking portion 18 in an iron core piece 16 of a laminated iron core according to a third embodiment of the present disclosure. In the caulking portion 18, a pair of extended portions 22 do not have a pair of outer-side planar portions 24, but are constructed only by a pair of sloped portions 23. End portions 23A of an opposite side to a planar portion 20 in a pair of sloped portions 23 are directly connected, in one example, to a main body 17 of the iron core piece 16. End surfaces 23A1 heading for an outer side of the caulking portion 18 in a lengthwise direction are formed at the end portions 23A. The end surfaces 23A1 are arranged vertically or approximately vertically with respect to the lengthwise direction of the caulking portion 18. In this embodiment, a pair of extended portions 22 do not have a pair of outer-side planar portions 24. Therefore, it is easy to form the caulking portion 18 in comparison with the first embodiment. In this embodiment, the other structures than the above are the same as the first embodiment. Therefore, the same effects as the first embodiment can be basically obtained except the above points. This embodiment may be structured such that the end portions 23A mentioned above are not directly connected to the main body 17 of the iron core piece 16.

### Fourth Embodiment

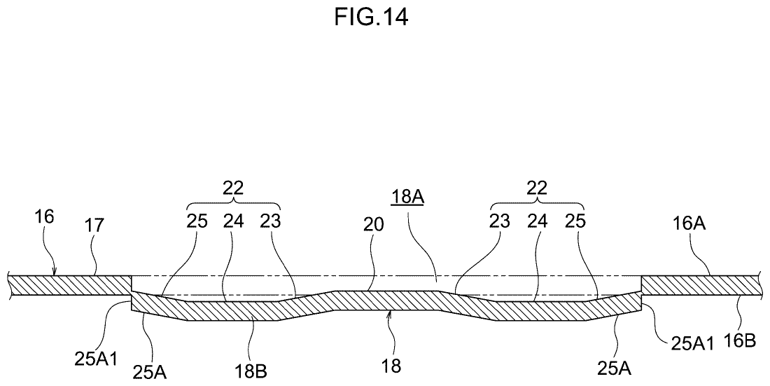

FIG. 14 is a cross sectional view showing a structure around a caulking portion 18 in an iron core piece 16 of a laminated iron core according to a fourth embodiment of the present disclosure. In the caulking portion 18, a pair of extended portions 22 have a pair of outer-side sloped portions 25 which extend obliquely toward an opposite side of the caulking portion 18 in a lengthwise direction and one side of the iron core piece 16 in a thickness direction each other from an end portion of an opposite side to a pair of sloped portions 23 in a pair of outer-side planar portions 24. End portions 25A of an opposite side to the outer-side planar portions 20 in the outer-side sloped portions 25 are directly connected, in one example, to the main body 17 of the iron core piece 16. End surfaces 25A1 heading for an outer side of the caulking portion 18 in a lengthwise direction are formed at the end portions 25A. The end surfaces 25A1 are arranged vertically or approximately vertically with respect to the lengthwise direction of the caulking portion 18. This embodiment may be structured such that the end portions 25A mentioned above are not directly connected to the main body 17 of the iron core piece 16.

In this embodiment, it is possible to guide the caulking fitting between the caulking portions 18 of the iron core pieces 16 by a pair of outer-side sloped portions 25. Further, a pair of outer-side sloped portions 25 are thinner at least partly (approximately all in this case) than the main body 17. Therefore, a pair of outer-side sloped portions 25 are hard to be interfered with each other in the thickness direction of the iron core piece 16. As a result, the gap between plates is hard to be generated. In this embodiment, the other structures than the above are the same as the first embodiment. Therefore, the same effects as the first embodiment can be basically obtained except the above points.

### Fifth Embodiment

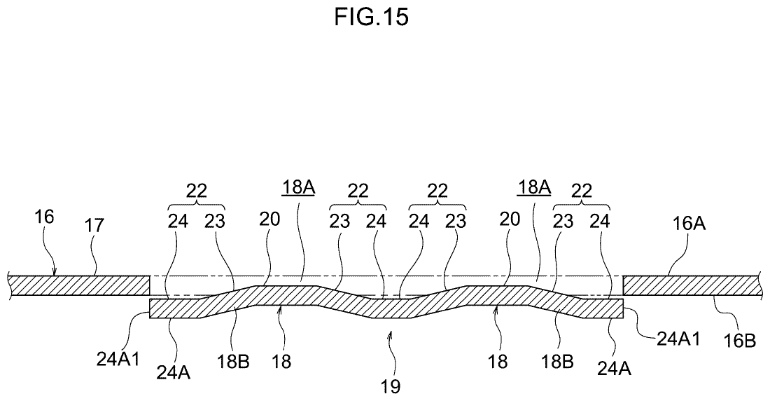

FIG. 15 is a cross sectional view showing a structure around a caulking portion 19 in an iron core piece 16 of a laminated iron core according to a fifth embodiment of the present disclosure. The caulking portion 19 is formed such that a plurality of (two here) caulking portions 18 are connected to each other in their respective lengthwise directions. A dimension of each of the caulking portions 18 in a lengthwise direction is set to be about half of the first embodiment. In particular, in an outer-side planar portion 24 in a mutually connected side in each of the caulking portions 18, the dimension in the lengthwise direction is set to be short. In this embodiment, the caulking portion 19 is constructed by a plurality of caulking portions 18. Therefore, it is possible to increase a contact area between the caulking portions 19, for example. As a result, it is possible to enhance a caulking force of the iron core piece 16 in a thickness direction. Further, both end portions of the caulking portion 19 in a lengthwise direction is adapted not to be directly connected to the main body 17 of the iron core piece 16. Thus, the same effect as the second embodiment can be obtained. In this embodiment, the other structures than the above are the same as the first embodiment. Therefore, the same effects as the first embodiment can be basically obtained except the above points. This embodiment may be structured such that both end portions of the caulking portion 19 in the lengthwise direction are directly connected to the main body 17 of the iron core piece 16.

### Sixth Embodiment

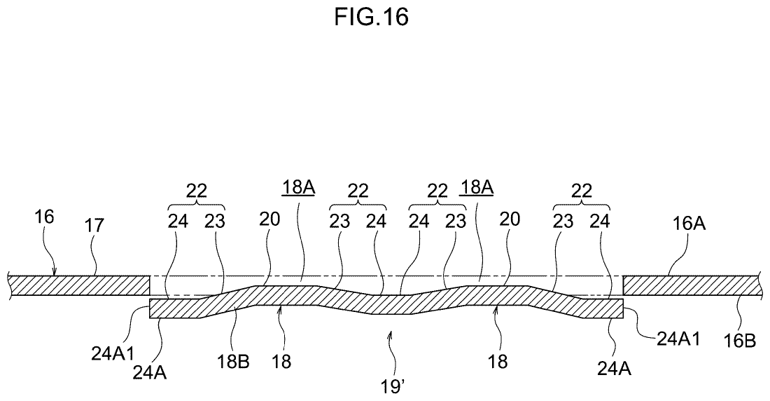

FIG. 16 is a cross sectional view showing a structure around a caulking portion 19′ in an iron core piece 16 of a laminated iron core according to a sixth embodiment of the present disclosure. The caulking portion 19′ is similar to the caulking portion 19 according to the fifth embodiment, and is formed such that two caulking portions 18 are connected to each other in their respective lengthwise directions. In the caulking portions 19′, outer-side planar portions 24 in a mutually connected side and outer-side planar portions 24 mutually positioned in opposite sides are arranged at different positions from each other in a thickness direction of the iron core piece 16, in two caulking portions 18. Therefore, it is possible to enhance a degree of freedom for setting a caulking force between the caulking portions 18 in the outer-side planar portions 24.

In each of the embodiments mentioned above, the description is given of the case where the present disclosure is applied to the laminated iron core of the rotor. However, the present disclosure is not limited to them, but can be applied to a laminated iron core of a stator.

In addition, the present disclosure can be variously modified and implemented within a range which does not deviate from the scope of the disclosure. Further, it goes without saying that the scope of the present disclosure is not limited to each of the embodiments mentioned above.

Further, the disclosure of Japanese Patent Application No. 2021-041801 filed in Mar. 15, 2021 is entirely incorporated into the present specification through reference. All the documents, patent applications and technical standards described in the present specification are incorporated into the present specification through reference in the same degree that the respective documents, patent application and technical standards are specifically and individually described to be incorporated through reference.

1. A method of manufacturing a laminated iron core by fitting elongate caulking portions, formed in each of iron core pieces via press working, to each other and laminating and fixing the iron core pieces to each other,
the method comprising the steps of:
forming a planar portion, which is connected to a main body of the iron core piece when forming the caulking portion, which is formed into a concave shape with respect to a face of one side of the iron core piece in a thickness direction, which is formed into a convex shape with respect to a face of another side of the iron core piece in the thickness direction, and which is parallel to each of the faces, and
forming a pair of extended portions having a pair of sloped portions which extend obliquely toward an opposite side in a lengthwise direction and another side in the thickness direction from both ends of the planar portion in the lengthwise direction of the caulking portions; and
extending the pair of sloped portions in an oblique direction when forming the pair of sloped portions.

2. A laminated iron core in which elongate caulking portions formed in each of iron core pieces according to press working are fitted to each other and each of the iron core pieces is laminated and fixed to each other,
wherein the caulking portion includes:
a planar portion which is connected to a main body of the iron core piece, which is formed into a concave shape with respect to a face of one side of the iron core piece in a thickness direction, which is formed into a convex shape with respect to a face of another side of the iron core piece in the thickness direction, and which is parallel to each of the faces; and
a pair of extended portions having a pair of sloped portions which extend obliquely toward an opposite side in a lengthwise direction and another side in the thickness direction from both ends of the planar portion in the lengthwise direction of the caulking portions, and are thinner, at least partly, than the main body of the iron core piece.

3. The laminated iron core according to claim 2, wherein the pair of extended portions have a pair of outer-side planar portions which extend toward an opposite side in the lengthwise direction from an end portion of an opposite side to the planar portion in the pair of sloped portions, and which are parallel to each of the faces.

4. The laminated iron core according to claim 2, wherein, in a case in which the thickness of the iron core piece is 1, a depth that the planar portion is recessed from the face of the one side in the thickness direction is set to a range from 0.15 to 0.85.

5. The laminated iron core according to claim 2, wherein the pair of extended portions are directly connected to the main body at an end portion at an opposite side to the planar portion.

6. The laminated iron core according to claim 2, wherein the pair of extended portions are not directly connected to the main body at the end portion at an opposite side to the planar portion.

7. The laminated iron core according to claim 2, wherein a plurality of caulking portions are formed in each of the iron core pieces so as to be connected to each other in the lengthwise direction.

8. The laminated iron core according to claim 3, wherein the pair of extended portions have a pair of outer-side sloped portions which extend obliquely toward the opposite side in the lengthwise direction and the one side in the thickness direction from the end portion of the opposite side to the pair of sloped portions in the pair of outer-side planar portions, and which are thinner, at least partly, than the main body.

9. The laminated iron core according to claim 3, wherein each of the outer-side planar portions includes structures which are arranged at different positions from each other in the thickness direction.
